(19) United States
(12) Patent Application Publication
(10) Pub. No.: US 2005/0132852 A1
(43) Pub. Date: Jun. 23, 2005

(54) Paper roll edge trimming method and apparatus

(76) Inventors: Joseph Thomas Walsh, Sartell, MN (US); Russell George Smart, Sauk Rapids, MN (US)

Correspondence Address: Richard C. Stewart II, 6285 Tri Ridge Blvd., Loveland, OH, 45140-7910, US

(21) Appl. No.: 10/738,004

(22) Filed: Dec. 17, 2003

(51) Int. Cl. B26D 1/00

(52) U.S. Cl. 83/13; 83/801

(57) ABSTRACT

The present invention is directed to a method and apparatus for precisely controlled and operator safe removal of a desired width of layered paper from the end of a roll of paper web, as for example a paper roll having one or both ends damaged, employing a compound mount for a knife-blade type cutter which is selectively adjustable along multiple axes relative to the rotational axis and width of the paper roll as the roll is rotated independently of the cutter and without unwinding the paper web from the roll. In accordance with one aspect of the present invention, only that quantity of paper web, which is damaged, is removed while maximizing the depth of cut radially into the roll by the cutter.

### CROSS-REFERENCE TO RELATED APPLICATIONS

Not Applicable

### STATEMENT REGARDING FEDERALLY SPONSORED RESEARCH OR DEVELOPMENT

Not Applicable

### FIELD OF INVENTION

This invention relates to trimming the ends of rolls of paper or the like, such as for purposes of sizing the width of the roll or removal of damaged paper from the end of the roll.

### BACKGROUND OF INVENTION

Formed paper webs are commonly collected in rolls for storage, transport and otherwise handling in the course of conversion of the web into some desired form. In storage, during handling, etc., the ends of these rolls of paper are subjected to becoming damaged, contaminated, wetted or subjected to other destructive treatment which results in the paper adjacent an end of the roll being rendered unusable or undesirable for the intended use of the paper web of the roll. Rolls of paper web may be relatively small, but commonly the web is collected in a jumbo roll which weighs many hundreds of pounds.

In the process of converting the paper web from a roll into a desired product, the web must be unrolled from the basic roll and fed into a converting machine, of which there are many types. In any event, where one or both of the ends of the roll have experienced moisture, the layers of paper web, at the ends of the roll tend to bond together for a relatively short distance inwardly of the roll from the end thereof. This distance may be as short as about ¼ inch or can be more pervasive inwardly of the width of the roll. Such bonded layers of the paper web tend to cause the paper web to resist unwinding such that the web breaks as it is unwound from the roll. Each such break requires a “shut-down” of the conversion machine to re-thread the web into the machine, costing time and money to process the roll of paper web.

The prior art includes devices for cutting the ends of a roll of paper such as by sawing, grinding or similar removal of the damaged portion of the end of the roll. Such devices create potentially hazardous amounts of paper dust, and in some instances are inherently hazardous to operate or expensive to protect against operator injury. Other prior art devices are deficient with respect to control over the cutting operation, resulting in loss of valuable paper or inadequate removal of paper from the end of the roll. Moreover, known prior art devices tend to create a less than square end of the cut roll, often leaving ridges and valleys defined in the cut end of the roll.

### SUMMARY OF INVENTION

In the present invention there is provided a method and apparatus for precisely controlled and operator safe removal of a desired width of layered paper from the end of a roll of paper web employing a compound mount for a knife-blade type cutter which is selectively adjustable along multiple axes relative to the rotational axis and width of the paper roll as the roll is rotated independently of the cutter and without unwinding the paper web from the roll. In accordance with one aspect of the present invention, only that quantity of paper web which is damaged is removed while maximizing the depth of cut radially into the roll by the cutter.

In the method of the invention, a paper roll having one or both ends damaged, is mounted for rotation about a central axis thereof. A cutter is mounted for selective movement along multiple axes relative to the rotational axis and width of the roll, and as the roll is rotated, the position of the cutter relative to the roll is adjusted initially a selected distance inwardly of the width of the roll and adjusted periodically as a function of the maximum permissible radial depth of cut made by the cutter.

### BRIEF DESCRIPTION OF FIGURES

FIG. 1 is a schematic representation of a typical roll of paper web mounted for rotation about a radially central axis and depicting various features of the present invention;

FIG. 2 is an exploded view of one embodiment of a cutter mounted for multi-directional movement when mounted on a carrier associated with the mounting rails for the roll of paper depicted in FIG. 1;

FIG. 3 is a top elevational representation of a knife-blade type cutter mounted in cutting position to the end of a paper roll;

FIG. 4 if a schematic representation of a knife-blade cutter of the present invention mounted in a blade mount;, and

FIG. 5 is a top view of a portion of the apparatus depicted in FIG. 1 and without any cut having been made on the end of the roll.

### DETAILED DESCRIPTION OF INVENTION

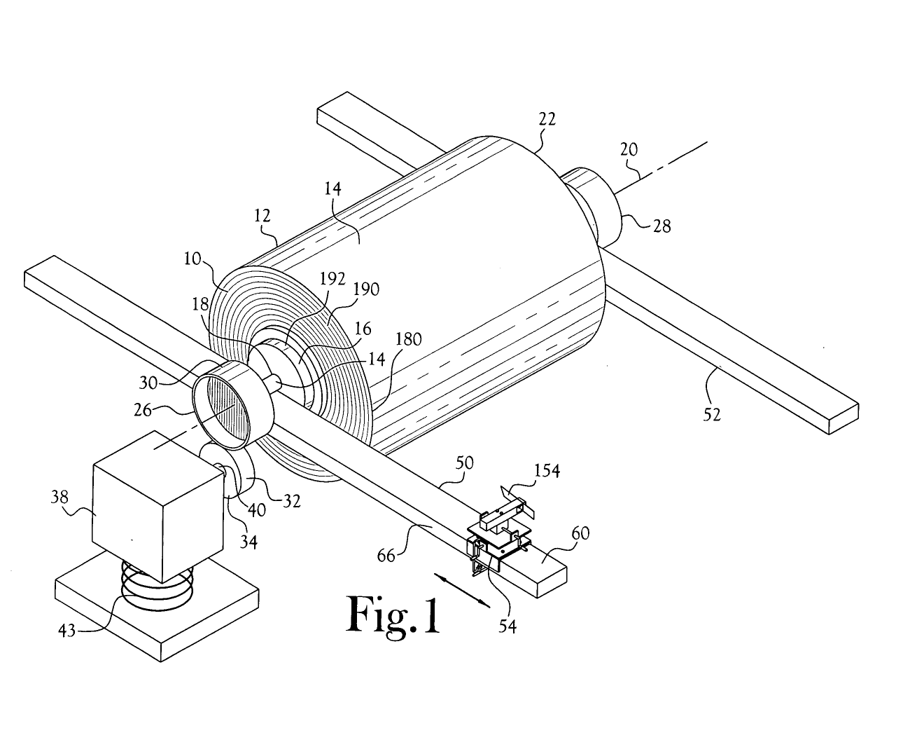

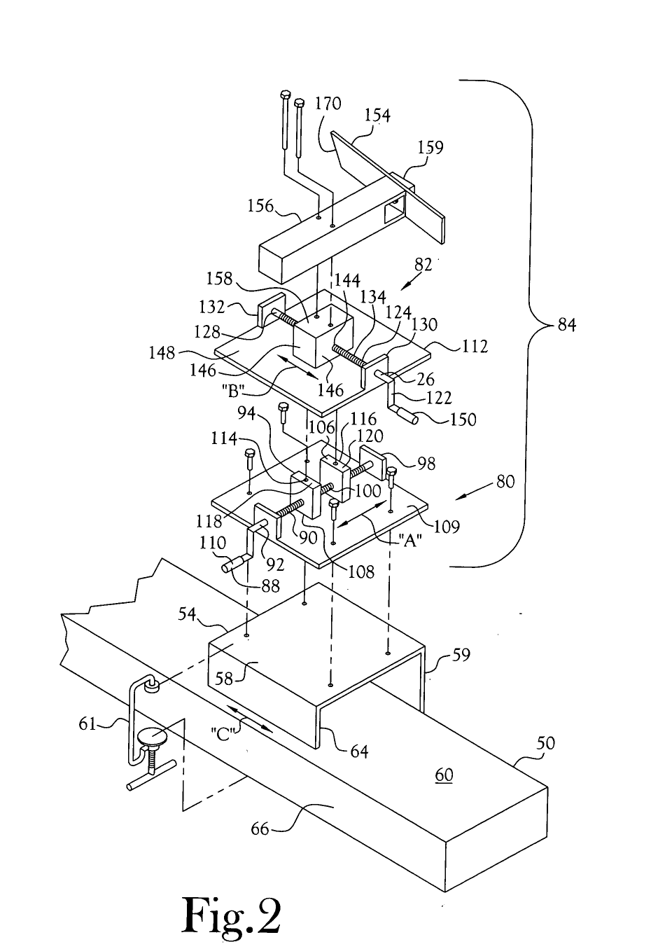

With reference to FIGS. 1 and 2, in one embodiment of the present invention, there is provided apparatus for severing or cutting away a selected portion of an end 10 of a roll 12 of paper web 14. The depicted roll includes a spool 16 upon which the paper web is wound to generate the roll. The depicted spool is fitted with a shaft 18 which extends through the central axis of the spool and beyond the opposite ends 10 and 22 of the depicted roll to define a rotational axis 20 for the roll.

As depicted in FIG. 1, each end of the shaft which projects beyond the respective ends of the roll is provided with a disc 26,28 oriented substantially perpendicular to the rotational axis of the shaft/roll and fixed to the shaft for rotation of the shaft upon rotation of the disc. As also depicted in FIG. 1, the disc 26 includes an outer circumferential surface 30. For rotation of the roll about its rotational axis, the outer circumferential surface of the disc is engaged by the outer circumferential surface 32 of a tire 34 fabricated of a frictional material or having a frictional material coating its outer circumferential surface 36, whereby rotation of the tire effects rotation of the disc, hence rotation of the roll of paper web.

Rotation of the tire is effected by means of a conventional motor 38, preferably including a conventional speed control means (not shown), and including a drive shaft 40 upon which the tire is mounted. As desired, the motor may be mounted upon a conventional air support 43 to provide for adjustment of the frictional engagement between the outer circumferential surface of the tire and the outer circumferential surface of the disc.

As seen in FIG. 1, those portions 44, 46 of the shaft which project beyond the opposite ends of the roll reside on respective rails 50,52 and are supported for rotation of the shaft thereon. Positioning of the shaft relative to the rails may be by any of several suitable means (not shown) such as “V” notches cut into the top surface of each rail, a pair of stops provided on each rail and spaced apart by a distance sufficient to receive the shaft therebetween, or other known means.

In accordance with the present invention, there is provided on at least one of the rails, a carrier 54 which in the depicted embodiment takes the form of a metal plate 56 which in bent into an “L” shape cross section. The body 58 of the “L” overlies the upper surface 60 of the rail with the longer leg 59 of the “L” lying along an inner surface 62 of the rail and the shorter leg 64 of the “L” lying along the outboard surface 66 of the rail. This carrier is slidably moveable along the length of the rail as indicated by the arrow “C” of FIG. 2, and may be selectively and temporarily fixed at any desired location along the length of the rail as by a “C” clamp 61 or other releasable fastening means, such as a stud threaded through the shorter leg 64 of the “L” and frictionally engaging the outboard surface 66 of the rail. Whereas there is depicted a carrier only on one rail, it is to be understood that a mirror image carrier may be provided on the opposite rail.

Such additional carrier functioning in like manner as the carrier 54 for purposes of the present invention.

Referring to FIG. 2 specifically, the present invention further includes first and second elements 80 and 82, respectively, of a compound 84.

The first element 82 of the compound includes a planar rigid plate 86 adapted to be affixed to the carrier 54 for movement with the carrier along the length of the rail. The plate 86 is fitted with a crank 88 having a shaft 90 which is rotatably supported at its opposite ends 92,94 by upstanding journal bearings 96 and 98. The central portion 100 of the crank shaft is provided with external threads and is threadably received within first and second blocks 104,106, each of which is provided with an internally threaded throughbore for receipt of the threaded portion of the crank shaft. Each block, block 104 being typical, includes a flat bottom surface 108 which is disposed in sliding relationship to the top surface 109 of the plate and which is not-rotatable with respect to the crank shaft. Consequently, upon rotation of the crank shaft as by rotation of the crank handle 110, the blocks 104,106 simultaneously slide over the top surface of the plate in the direction of the arrow “A”, the direction of movement being determined by the direction of rotation of the shaft and the extent of their movement being determined by the rotational turns of the shaft.

The second element 84 of the compound includes a planar rigid plate 112 adapted to be affixed to, and carried with, the blocks 104, 106 of the first element 80 of the compound. The fixation of the plate 112 to the blocks may be by means of screws or bolts passing through the thickness of the plate 112 and being threadably received within internally threaded blind bores 114,116 provided in the top surfaces 118,120 of the blocks. Thus movement of the plate 112 in the direction depicted by the arrow “A” is effected upon movement of the blocks associated with the first element of the compound.

The plate 112 of the second element is fitted with a crank 122 having a shaft 124 which is rotatably supported at its opposite ends 126,128 by upstanding journal bearings 130 and 132. The central portion 134 of the shaft 124 is provided with external threads and is threadably received within a cutter mount block 140 which is provided with an internally threaded throughbore 144 for receipt of the threaded portion of the shaft 124. The block 140 includes a flat bottom surface 146 which is disposed in sliding relationship to the top surface 148 of the plate 112 and which is non-rotatable with respect to the shaft 124. Consequently, upon rotation of the shaft 124 as by rotation of the crank handle 150, the block 140 slides over the top surface of the plate in the direction of the arrow “B”, the direction of movement being determined by the direction of rotation of the shaft and the extent of the block's movement being determined by the rotational turns of the shaft.

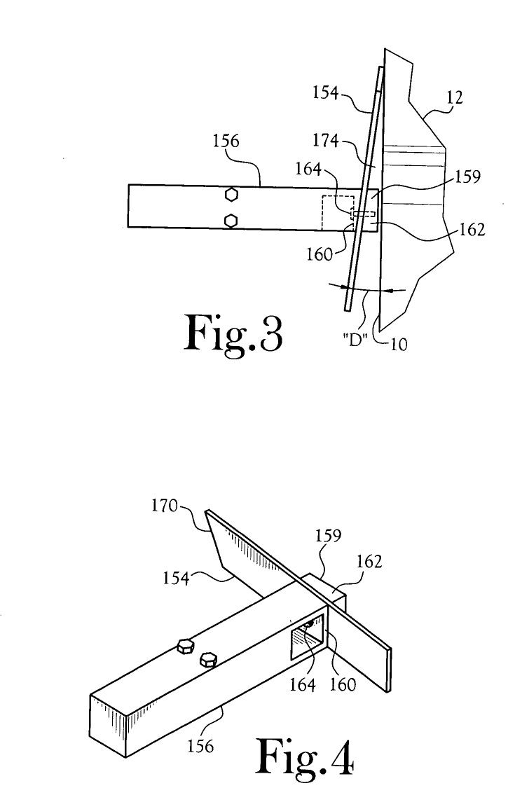

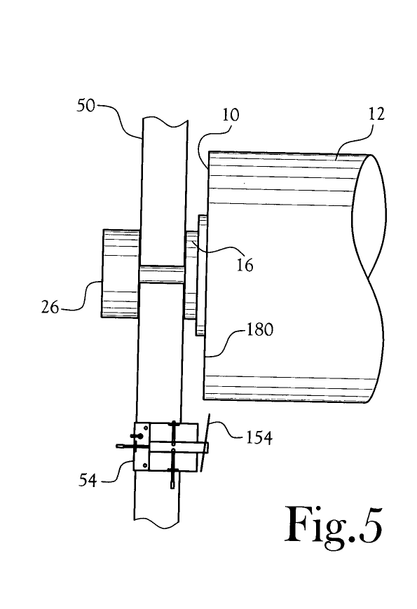

Further referring to FIGS. 2-4, the second component of the compound is provided with a cutting blade 154 which is removable mounted on a blade carrier 156, which, in turn, is fixedly mounted to the top surface 158 of the block 140. The depicted carrier 156 is a hollow metal tube having a rectangular cross-section. The depicted blade is an elongated flat blade and, in the depicted embodiment, is releasably secured within the outboard end 159 of the blade carrier between facing first and second mounting blocks 160, 162, respectively which are mounted within the end 159 of the carrier. These blocks are spaced apart by a distance sufficient for the blade to be slidably positioned between the blocks. The space defined between the blocks is planar and occupies a plane which is non-parallel to the plane of the end 10 of the roll 12. The magnitude of the angle “D” may vary substantially upwardly from about three degrees. Seven degrees has been found useful for cutting paper web rolls. As seen in FIG. 3, the plane of the blade disposed in the space between the blocks is oriented at an angle “D” with respect to the plane occupied by the end of the roll which is to be cut. Once the blade in disposed in a desired position between the blocks, the blade is anchored between the blocks as by a set screw 164 or like anchoring means.

The cutting blade includes a very sharp cutting end 170 which projects laterally and outboard of the blade carrier 156 and outboard of the side edge 172 of the plate 112 in cantilevered fashion to be in position for presentation to and engagement of the cutting end 170 of the blade with the end 10 of the roll 12 for severing away a portion of the end of the roll as the roll is rotated past the cutting end of the blade. As noted, in the depicted embodiment, the plane of the blade preferably is oriented at an angle with respect to the plane of the end of the roll thereby defining a relief 174 between the blade and the roll to ensure efficient and clean cutting of the paper on the roll. Further, when the blade is disposed properly for cutting the end of the roll, the relief permits the outboard end 159 of the carrier 156 to be disposed distant from the end of the roll, hence the carrier does not engage the end of the roll as cutting progresses. Still, further, in a preferred embodiment, the blade is substantially rigid and is mounted rigidly within the carrier 156 and relative to the compound element 84 to which the carrier 156 is secured to ensure controlled positioning of the cutting end of the blade relative to the end 10 of the roll 12 upon actuation of one or both of the compound elements 80 and 82.

In accordance with the method of the present invention, the compound 82 is mounted on the carrier 54 which, in turn, is mounted on the rail 50 for slidable positioning of the carrier 54 along the length of the rail. Initially, the carrier is releasably fixed at a location along the rail which positions the cutting end of the cutter blade contiguous to the outer rim 180 (FIG. 1) of the roll of paper web. Thereupon, the operator turns the crank handle 110 to position the cutting edge of the blade inwardly of the width of the roll by that distance which will permit the blade to cut away from the end of the roll the desired portion of the width of the roll. This distance may range from a fraction of an inch, e.g., one-fourth inch, to multiple inches, in part by reason of the relief defined between the blade and the end of the roll. As desired, the degree of relief defined by the orientation of the planar space between the blocks 104, 106 may be selected by changing the angular orientation of the space between the blocks, hence the angular orientation of the blade relative to the end of the roll. Among other things, this feature of the present invention permits the selection of relative large cut widths. Should the width of the cut be greater than the adjustment capacity of the apparatus, multiple cuts may be made, each being a portion of the total desired width of removed paper web from the end of the roll.

With the roll rotating about its axis, and with the cutting end of the blade disposed contiguous the outer circumference of the end of the roll, the operator turns the crank handle 150 which moves the cutting end of the blade 154 radially relative to the rotational axis of the roll to select the desired depth of the cut into the end of the roll. As the roll is rotating, the operator turns the crank 150 to move the cutting end of the blade in a direction radially inwardly or outwardly of the roll until the desired radial depth of the cut is achieved. This radially inwardly movement of the cutting edge of cutting end of the blade is controlled by the operator as the cut progresses to maintain a maximum depth of cut, thereby minimizing the time required to sever the entire end of the roll.

Notably, the present invention provides for the cutting edge of the blade to be maintained in its cutting position until the cutting edge has reached the spool of the roll, thereby ensuring a full cutting away of the end of the roll. Moreover, the degree of adjustment of the cutting end of the blade relative to the end of the roll provides the operator the means whereby there may be performed a clean and even cut over the entire end of the roll. A partially cut end of the roll is depicted in FIG. 1 and shows a smooth cut portion 190 of the end of the roll and an uncut portion 192 of the end of the roll adjacent the spool 16.

Importantly, the present invention provides for the clean, even cutting away of the paper web from the roll without unwinding of the paper web from the roll. As desired, however, the cutting away of the end of the roll also may be performed as the paper web is being unwound from the roll. In this latter instance, the depth of cut is adjusted to ensure that at all times the paper web has been cut before it leaves the roll. This latter arrangement is-possible by positioning the location of the cutting operation at a location along the outer circumference of the roll that is located ahead of the location where the paper web leaves the roll (such as depicted in FIG. 1). Further, the present invention permits the operator to manually select the depth of cutting of the blade to accommodate areas of the end of the roll which are more dense due to their being subjected to more severe damage than other areas of the end of the roll, thereby again enhancing the minimization of the time required to fully sever the desired paper web from the end of the roll. Still further, as noted, a device of the present invention may be provided at each of the opposite ends of the roll for simultaneously severing paper web from each end of the roll.

Paper severed from the roll employing the present invention is in the form of small pieces or continuous strips, both of which are recoverable for recycling. No material dust from the paper on the roll is generated by the present invention. Thus, the present invention provides for material savings over the prior art devices which grind or saw away paper from a roll with the generation of large quantities of dust which is lost to recycling and which is recognized health hazard to operators, etc.

In the embodiment depicted herein, the paper roll is mounted for rotation on rails and the carrier 54 is slidably mounted on a rail. It will be recognized that the carrier 54 may be supported on a mount which is separate from the support for the paper roll.

Whereas the present invention has been described herein at times using specific examples, one skilled in the art will recognize that various modifications and/or substitutions may be made without departing from the essentials of the present invention. It is therefore intended that the invention be limited only as set forth in the claims appended hereto.

1. Apparatus for removing damaged paper from the end of a paper web wound in a roll having a rotational axis comprising means for mounting said roll of paper web for rotation about its rotational axis, means for cutting away a desired portion of an end of said roll of paper web, said means for cutting including a carrier mounted for reciprocatory movement between minimum and maximum distances from the rotational axis of the roll, said minimum distance being contiguous the rotational axis of the roll, means for anchoring said carrier at a selected location between said minimum and maximum distances, a mechanical compound slide mounted on said carrier and moveable therewith, said compound slide including a first planar plate mounted on said carrier for reciprocatory movement with said carrier and having an upper surface, at least one movable block disposed on said upper surface of said first plate, means for selectively and reciprocatorily adjusting the position of said block on said upper surface, a second planar plate mounted on said at least one movable block on said first plate for movement of said second plate with movement of said at least one block and having an upper surface, at least one further movable block disposed on said upper surface of said second plate, means for selectively and reciprocatorily adjusting the position of said at least one further movable block on said upper surface of said second plate, a blade carrier mounted on said further movable block for movement with said further movable block, an elongated knife-blade type cutter having a cutting end and being mounted on said blade carrier and moveable therewith for presentation to and cutting engagement of said cutting end with one end of the paper roll, whereupon rotation of the paper roll while said cutter is in cutting engagement with the paper roll effects severing of a portion of the end of the paper roll.

2. The apparatus of claim 1 wherein movement of said at least one moveable block mounted on said first plate is restricted to reciprocatory movement along a first path and movement of said at least one further moveable block mounted on said second plate is restricted to reciprocatory movement along a second path which is substantially perpendicular to said first path.

3. The apparatus of claim 2 wherein said first path is oriented substantially parallel to the rotational axis of the paper roll.

4. The apparatus of claim 1 Wherein said blade includes a cutting end and is mounted on said blade carrier with said cutting end facing the paper roll and with the plane of said blade oriented at an angle relative to the plane of the end of the paper roll, thereby defining a relief between said blade and said end of the paper roll.

5. The apparatus of claim 4 wherein said angle is greater than about three degrees.

6. The apparatus of claim 1 wherein said means for selectively and reciprocatorily adjusting the position of,said moveable block associated with said first plate comprises a crank including an externally threaded shaft received within an internally threaded throughbore through said moveable block whereby rotation of said shaft effects movement of said moveable block, the direction of such movement being a function of the direction of rotation of said shaft and the extent of said movement being a function of the number of rotations of said shaft.

7. The apparatus of claim 1 wherein said means for mounting the roll of paper web for rotation about its rotational axis includes rail means disposed alongside at least one end of the roll and said carrier is mounted for movement along said rail means toward or away from the paper roll.

8. The apparatus of claim 7 and including means for securing said carrier to said rail means at a substantially infinite number of positions between minimum and maximum distances along said rail means from said rotational axis of the roll, said minimum distance being established contiguous to said rotational axis.

9. Apparatus for removing damaged paper from the end of a paper web wound in a roll having a rotational axis comprising means for mounting said roll of paper web for rotation about its rotational axis, means for cutting away a desired portion of an end of said roll of paper web, said means for cutting including a carrier mounted for reciprocatory movement between minimum and maximum distances from the rotational axis of the roll, said minimum distance being contiguous the rotational axis of the roll, means for anchoring said carrier at a selected location between said minimum and maximum distances, a mechanical compound slide mounted on said carrier and moveable therewith, said compound slide including at least first and second blocks mounted on said carrier for reciprocatory movement relative to one another along mutually perpendicular paths, said path of said at least first block being oriented substantially parallel to the rotational axis of the roll and said path of said at least one second block being oriented substantially perpendicular to the rotational axis of the roll, a cutter anchored on said at least one second block whose path is oriented substantially perpendicular to the rotational axis of the roll and having a distal cutting end which projects from said block in position to engage the end of the roll, whereby movement of said at least one first block along its respective path adjusts the proximity of said distal cutting end of said cutter relative to the end of the roll and movement of said at least one second block along its respective path adjusts the proximity of said distal cutting end of said cutter relative to the rotational axis of the roll to thereby cut away a selected portion of the end of the roll.

10. The apparatus of claim 9 wherein said means for mounting the roll of paper web for rotation about its rotational axis includes rail means disposed alongside at least one end of the roll and said carrier is mounted for movement along said rail means toward or away from the roll.

11. The apparatus of claim 10 and including means for securing said carrier to said rail means at a substantially infinite number of positions between minimum and maximum distances along said rail means from said rotational axis of the roll, said minimum distance being established contiguous to said rotational axis.

12. The apparatus of claim 9 wherein said cutter comprises a knife-blade type cutter having an outboard cutting end.

13. The apparatus of claim 12 wherein said cutter occupies a plane which is oriented at an angle with respect to the plane of the end of the paper roll, thereby defining a relief between said cutter and the end of the paper roll.

14. The apparatus of claim 13 wherein said angle of orientation of the plane of said cutter relative to the plane of the end of the paper roll is greater than about 3 degrees.

15. A method for removing paper web from an end of a roll of the paper web comprising the steps of mounting said roll of paper web for rotation of the roll about a central axis thereof, mounting a knife-blade type cutter having an outboard cutting end for multidirectional movement radially of the central axis of the roll and laterally of the roll, engaging the end of the roll of paper web with the outboard end of the cutter, rotating the roll of paper web about its central axis, while the roll is rotating about its central axis, periodically independently adjusting the proximity of the cutter to the end of the roll, thereby selectively cutting away the a portion of the end of the roll prior to unwinding the paper web from the roll, while minimizing the quantity of paper web removed from the end of the roll and maximizing the depth of cut of the cutter into the rotating roll of paper web.

16. The method of claim 15 and including the steps of orienting the plane of the knife-type blade cutter at an angle relative to the plane of the end of the roll whereby there is developed a relief between the cutter and the end of the roll when the cutting end of the cutter is in cutting engagement with the end of the roll.

17. The method of claim 16 wherein the angle of relief is greater than about 3 degrees.

18. The method of claim 15 wherein movements of said cutter relative to the roll are conducted manually.
